(19) United States
(12) Patent Application Publication
(10) Pub. No.: US 2026/0270505 A1
(43) Pub. Date: Sep. 10, 2026

(54) CHAPTER RECOGNITION

(71) Applicant: Beijing Zitiao Network Technology Co., Ltd., Beijing (CN)

(72) Inventors: Mei JIANG, Beijing (CN); Mingyu GUO, Beijing (CN); Mufeng LIU, Beijing (CN); Mingfei ZHANG, Beijing (CN); Jinfan XU, Beijing (CN); Xiaojia CHEN, Beijing (CN); Peiping LUO, Beijing (CN); Fanqi MENG, Beijing (CN)

(21) Appl. No.: 19/559,526

(22) Filed: Mar. 6, 2026

(30) Foreign Application Priority Data
Mar. 7, 2025 (CN) 202510273347.1

(51) Int. Cl. H04N 21/44; H04N 21/854

(52) U.S. Cl. CPC H04N 21/44008; H04N 21/854

(57) ABSTRACT

Embodiments of the disclosure relate to a method, an apparatus, a device, and a storage medium for chapter recognition. The method includes: obtaining an image frame of video content; determining a set of text content in the image frame by using a first recognition model; constructing a prompt based on the set of text content; and providing the image frame and the prompt to a second recognition model to determine chapter information of the video content, the chapter information indicating a plurality of chapter titles of the video content. According to the embodiments of the disclosure, the chapter information of the video content can be accurately recognized.

### CROSS-REFERENCE

The present application claims priority to Chinese Patent Application No. 202510273347.1, filed on Mar. 07, 2025, and entitled "METHOD, APPARATUS, DEVICE, AND STORAGE MEDIUM FOR CHAPTER RECOGNITION", which is incorporated herein by reference in its entirety.

### TECHNICAL FIELD

Example embodiments of the present disclosure generally relate to the field of computers, and in particular, to chapter recognition.

### BACKGROUND

With the rapid development of computer technology, short video social platforms have gradually become social media for people. People may create video content and post it on short video social platforms to record and share their lives. When creating the video content, people may add a self-made progress bar to the video content, so as to facilitate others to watch the video content.

At present, the self-made progress bar of the user still fails to provide viewers with a good viewing experience.

### SUMMARY

In a first aspect of the present disclosure, a method for chapter recognition is provided. The method includes: obtaining an image frame of video content; determining a set of text content in the image frame by using a first recognition model; constructing a prompt based on the set of text content; and providing the image frame and the prompt to a second recognition model to determine chapter information of the video content, the chapter information indicating a plurality of chapter titles of the video content.

In a second aspect of the present disclosure, an apparatus for chapter recognition is provided. The apparatus includes: an obtaining module configured to obtain an image frame of video content; a first determining module configured to determine a set of text content in the image frame by using a first recognition model; a constructing module configured to construct a prompt based on the set of text content; and a second determining module configured to provide the image frame and the prompt to a second recognition model to determine chapter information of the video content, the chapter information indicating a plurality of chapter titles of the video content.

In a third aspect of the present disclosure, a computing device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium stores a computer program executable by a processor to implement the method of the first aspect.

It would be appreciated that content described in this section is neither intended to define key or essential features of the embodiments of the present disclosure, nor is it intended to limit the scope of the present disclosure. Other features of the present disclosure will be readily understood through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments according to the present disclosure may be implemented;

FIG. 2 illustrates a flowchart of an example process for chapter recognition according to some embodiments of the present disclosure;

FIG. 3 illustrates a process block diagram of an example process for chapter recognition according to some embodiments of the present disclosure;

FIG. 4 illustrates a schematic diagram of an example image of an image frame according to some embodiments of the present disclosure;

FIGS. 5A-5C illustrate example interfaces according to some embodiments of the present disclosure;

FIG. 6 illustrates a schematic structural block diagram of an example apparatus for chapter recognition according to some embodiments of the present disclosure; and

FIG. 7 illustrates a block diagram of a computing device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it would be appreciated that the present disclosure may be implemented in various forms and should not be construed as being limited to the embodiments set forth herein; on the contrary, these embodiments are provided for a more thorough and complete understanding of the present disclosure. It would be appreciated that the drawings and embodiments of the present disclosure are only for illustrative purposes, and are not intended to limit the protection scope of the present disclosure.

It would be noted that the titles of any section/sub-section provided herein are not restrictive. Various embodiments are described throughout this article, and any type of embodiment may be included under any section/sub-section. In addition, the embodiments described in any section/sub-section may be combined with any other embodiments described in the same section/sub-section and/or different section/sub-section in any manner.

In the description of the embodiments of the present disclosure, the term "include/comprise" and similar terms thereto should be construed as open-ended inclusions, that is, "include/comprise but not limited to". The term "based on" should be construed as "at least partially based on". The term "one embodiment" or "the embodiment" should be construed as "at least one embodiment". The term "some embodiments" should be construed as "at least some embodiments". Other definitions, either explicit or implicit, may also be included below. The terms "first", "second", etc. may refer to different or same objects. Other definitions, either explicit or implicit, may also be included below.

The embodiments of the present disclosure may involve user data, data acquisition, and/or data use. All these aspects comply with corresponding laws, regulations, and related provisions. In the embodiments of the present disclosure, all data collection, acquisition, processing, machining, forwarding, and use are performed on the premise that the user is informed and confirms. Correspondingly, when implementing the embodiments of the present disclosure, the type, use scope, use scenarios, etc., of data or information that may be involved and the like should be notified to the user in an appropriate manner according to the relevant laws and regulations, and the authorization of the user should be obtained in an appropriate manner in accordance with relevant laws and regulations. A specific manner of informing and/or authorizing may vary according to actual situations and application scenarios, and the scope of the present disclosure is not limited in this regard.

If the solutions in this specification and the embodiments involve personal information processing, the processing is performed on the premise that a legal basis is provided (for example, the consent of a personal information subject is obtained, or the processing is necessary for the performance of a contract, etc.), and is only performed within a specified or agreed scope. If the user refuses to process personal information other than necessary information required for a basic function, the user's use of the basic function will not be affected.

As mentioned above, at present, the self-made progress bar of the user fails to enable the viewer to accurately jump to a desired chapter, so that the viewer fails to obtain a good viewing experience.

To improve the viewing experience of the viewer, the short video social platform needs to recognize the video content uploaded by the user, to remake a progress bar based on chapter content in the video content. However, currently used chapter recognition methods fail to accurately recognize self-made chapter text in the video.

Embodiments of the present disclosure provide a chapter recognition solution. The solution includes: obtaining an image frame of video content; determining a set of text content in the image frame by using a first recognition model; constructing a prompt based on the set of text content; and providing the image frame and the prompt to a second recognition model to determine chapter information of the video content, the chapter information indicating a plurality of chapter titles of the video content.

In this manner, embodiments of the present disclosure are capable of recognizing the image frame of the video content by using the first recognition model to determine the set of text content. Furthermore, the image frame may be recognized by using the second recognition model in combination with the prompt constructed based on the set of text content, to determine the chapter information of the video content. The above manner can improve the accuracy of recognizing the self-made chapter text in the video content.

Various example implementations of the solution will be described in detail below in further combination with the drawings.

### Example Enviroment

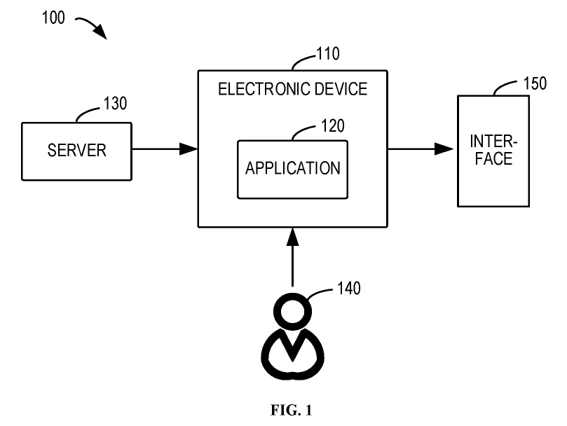

FIG. 1 illustrates a schematic diagram of an example environment 100 in which the embodiments of the present disclosure may be implemented. As shown in FIG. 1, the example environment 100 may include an electronic device 110.

In the example environment 100, the electronic device 110 may run an application 120 supporting chapter recognition. The application 120 may be any appropriate type of application for chapter recognition, examples of which may include but are not limited to a video social platform or other appropriate applications. A user 140 may interact with the application 120 via the electronic device 110 and/or its attached device.

In the environment 100 of FIG. 1, if the application 120 is active, the electronic device 110 may present an interface 150 for supporting chapter recognition through the application 120.

In some embodiments, the electronic device 110 communicates with a server 130 to implement the provision of the services of the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices or any combination thereof. In some embodiments, the electronic device 110 may also support any type of interface for the user 140 (such as a "wearable" circuit, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide background services for the application 120 supporting chapter recognition in the electronic device 110.

A communication connection may be established between the server 130 and the electronic device 110. The communication connection may be established in a wired or wireless manner. The communication connection may include, but is not limited to, a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interaction through the communication connection therebetween.

It would be appreciated that the structure and functions of the elements in the environment 100 are described only for the purpose of illustration, without suggesting any limitation to the scope of the present disclosure.

Some example embodiments of the present disclosure will be described below with continued reference to the drawings.

### Example Process

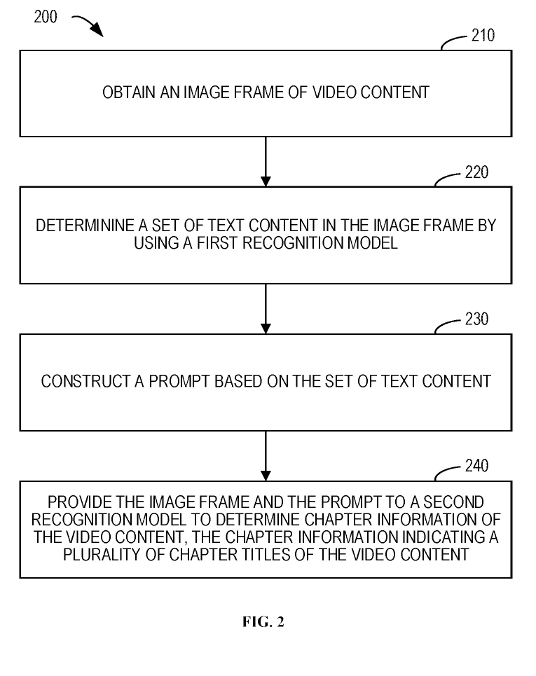

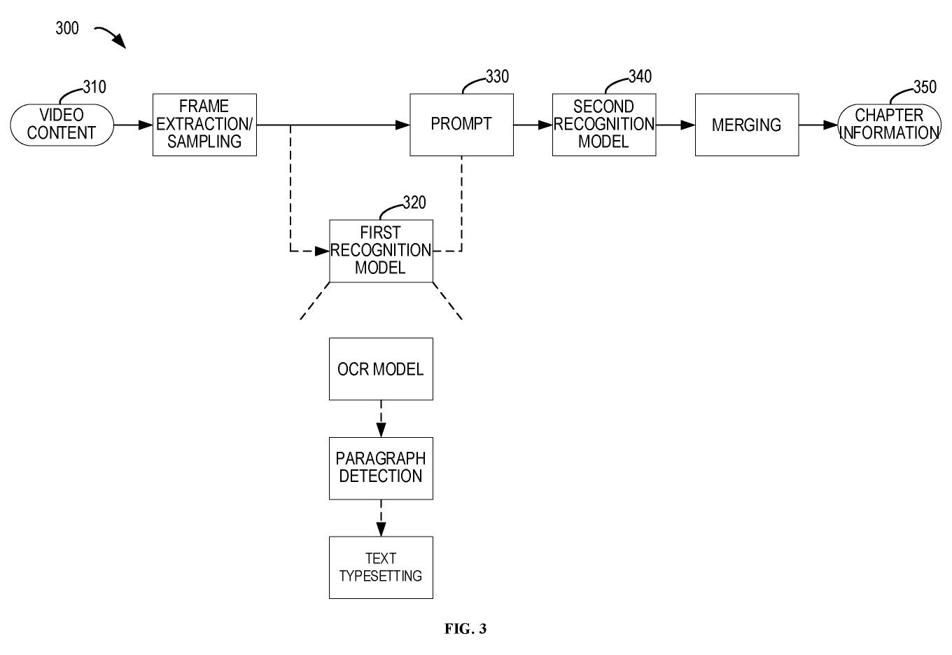

The specific process of chapter recognition will be described below with reference to FIGS. 2 and 3. FIG. 2 illustrates a flowchart of an example process 200 for chapter recognition according to some embodiments of the present disclosure. FIG. 3 illustrates a process block diagram of an example process 300 for chapter recognition according to some embodiments of the present disclosure. The process 200/the process 300 may be implemented at an appropriate device such as the electronic device 110. The process 200 will be described below with reference to FIGS. 1 and 3.

As shown in FIG. 2, at block 210, the electronic device 110 obtains an image frame of video content 310.

It would be appreciated that the chapter recognition method of the present disclosure may be used for recognizing self-made chapter text included in the images of the video content 310. As an example, such self-made chapter text is also referred to as a self-compressed chapter or a self-made progress bar. Generally, the progress bar added to the video content 310 may be seen in any image frame of the video content 310. Therefore, the electronic device 110 may recognize a plurality of chapter titles by recognizing the image frame in the video content 310.

In some embodiments, the electronic device 110 may obtain a plurality of image frames in the video content 310. As an example, the electronic device 110 may perform frame extraction sampling on the video content 310 to obtain the plurality of image frames. Specifically, for example, the electronic device 110 may sample the video content 310 at a predetermined frame extraction frequency. For example, the electronic device 110 may extract 3 to 10 image frames from the video content 310, so as to improve the accuracy of subsequent image frame recognition.

At block 220, the electronic device 110 determines, a set of text content in the image frame by using a first recognition model 320.

For the image frame, the text elements included therein may be, for example, subtitles, chapter information in the progress bar, and the text existing in the scene corresponding to the image frame. The electronic device 110 may recognize the above text elements from the image frame by using the first recognition model 320, to obtain the set of text content. Specifically, the first recognition model 320 may identify each text element in the image frame with a text box, that is, the first recognition model 320 may output a plurality of text boxes in the image frame and the text content in each text box. As an example, the first recognition model 320 may include, for example, an optical character recognition (OCR) model.

In some embodiments, after obtaining the plurality of text boxes of the image frame and the text content of the plurality of text boxes, the electronic device 110 may further use the first recognition model 320 to process the plurality of text boxes, to merge the plurality of text boxes. As an example, the electronic device 110 merges the plurality of text boxes by using the first recognition model 320, so that the plurality of text boxes may be merged according to the semantics of the corresponding text content, thereby facilitating the understanding of the second recognition model 340.

At block 230, the electronic device 110 constructs a prompt 330 based on the set of text content.

In some embodiments, the electronic device 110 may utilize the second recognition model 340 to process the image frame, to recognize the chapter information 350 of the video content 310. The chapter information 350 may indicate a plurality of chapters of the video content 310. In this process, the electronic device 110 may input not only the image frame to the second recognition model 340, but also the prompt 330 to the second recognition model 340.

In some embodiments, the electronic device 110 may construct the prompt 330 based on the following process: the electronic device 110 first determines the position information of the set of text content in the video content 310, and then constructs the prompt 330 based on the set of text content and the position information thereof. As an example, the position information may be, for example, coordinate information of the set of text content in the image frame.

In some embodiments, the prompt 330 may be used for indicating a task that needs to be executed by the second recognition model 340. For example, the prompt 330 may include the task that needs to be executed by the second recognition model 340, a requirement for an output result of the second recognition model 340, and a detailed explanation of the task that needs to be executed by the second recognition model 340. The detailed explanation of the task that needs to be executed by the second recognition model 340 indicates, in the present disclosure, a feature description associated with the chapter text to be recognized. The chapter text is the text element indicating the chapter information 350 in the image frame.

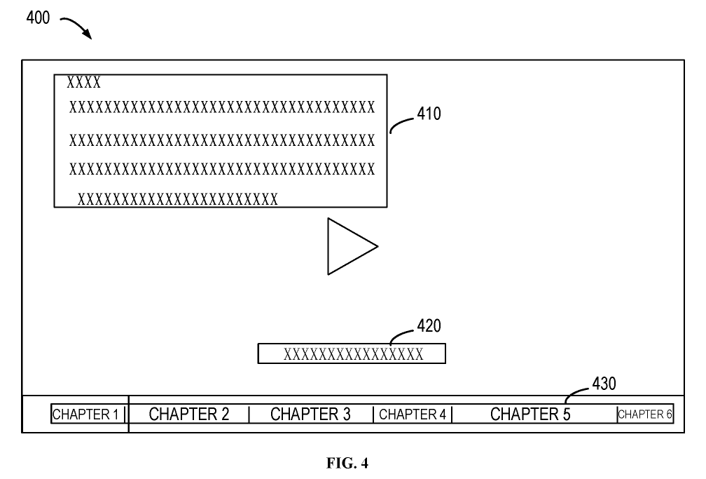

FIG. 4 illustrates a schematic diagram of an example image of an image frame according to some embodiments of the present disclosure.

As shown in FIG. 4, in a specific example, after an image frame of a video content is recognized by the first recognition model 320, a set of text content is determined. The set of text content includes the text content in a text box 410, the text content in a text box 420, and the text content in a text box 430. The text content in the text box 410 may be, for example, the text content in the scene corresponding to the image frame. The text content in the text box 420 may be, for example, a subtitle. The text content in the text box 430 is chapter text to be recognized.

In some embodiments, the feature description included in the prompt 330 may indicate at least one of: a position feature of the chapter text, a dynamic change feature of the chapter text, or a static visual feature of the chapter text. In some examples, the position feature of the chapter text indicates a position where the chapter text appears in the image frame. For example, the position feature may include that "the chapter text is usually located at the bottom edge or the top edge of the video and the position is relatively fixed".

As one further example, the dynamic change feature of the chapter text indicates a text element in the chapter text that changes as the image of the image frame changes. As an example, the dynamic change feature may include that "a dynamic effect of the progress bar is simulated through a change in the background color at the bottom of the chapter text or a change in the color of the chapter text itself".

As yet one further example, the static visual feature of the chapter text indicates a specific text element in the chapter text. As an example, the static visual feature may include that "the chapter content is displayed distinctively through background blocks, separators (|...), etc.".

As an example, the prompt 330 may be: "Please determine whether the image contains self-compressed chapter text according to the following explanations. If it does not, please output "No". If it does, please output the self-compressed chapter text separated by "|". Glossary: [Self-compressed chapter text] is usually located at the top or bottom of the video screenshot and is a self-made progress bar of the author, including chapter information 350 of the overall video content 310, usually having the following features: 1. It is often located at the bottom edge or the top edge of the video and the position is relatively fixed; 2. A dynamic effect of the progress bar is simulated through a change in the background color at the bottom of the chapter text or a change in the color of the chapter text itself; and 3. The chapter content is displayed distinctively through background blocks, separators (|...), etc.". Among them, "often located at the bottom edge or the top edge of the video and the position is relatively fixed" is the position feature of the chapter text. "Simulating the dynamic effect of the progress bar through the change in the background color at the bottom of the chapter text or the change in the color of the chapter text itself" is the dynamic change feature of the chapter text. "The chapter content is displayed distinctively through background blocks, separators (|...), etc." is the static visual feature of the chapter text. The prompt 330 may also be further similar words.

Additionally, the prompt 330 may further indicate layout information of the set of text content in the video content 310. The layout information may reflect the typesetting of the set of text content in the video content 310. In some embodiments, the layout information may be obtained based on the following process: the electronic device 110 performs conversion on the set of text content based on a typesetting module, to obtain the layout information.

In some embodiments, the electronic device 110 may convert the set of text content into the layout information according to a target layout after determining the target typesetting from the typesetting module. For example, the layout information may indicate the paragraph information of the recognized set of text content, and the text content corresponding to different paragraphs may be separated by a predetermined separator (for example, a comma) in the prompt 330.

The prompt 330 obtained in the above manner can enable the second recognition model 340 to recognize the image frame more accurately. The electronic device 110 may process each image frame in turn to obtain the prompt 330 corresponding to each image frame. After that, the electronic device 110 may use the second recognition model 340 to process a plurality of image frames, to determine the chapter information 350 of the video content 310. Specifically, when using the second recognition model 340 to process the plurality of image frames, the electronic device 110 may process each image frame in turn, or may use the second recognition model 340 to process the plurality of image frames concurrently. In the case where the second recognition model 340 processes each image frame in turn, the second recognition model 340 needs a plurality of prompts 330 corresponding to the plurality of image frames. In the case where the second recognition model 340 processes the plurality of image frames concurrently, the second recognition model 340 only needs one prompt 330. For example, the one prompt 330 may indicate the layout information of a plurality of sets of text content corresponding to the plurality of image frames. The plurality of image frames may include a first image frame and at least one second image frame.

At block 240, the electronic device 110 provides the image frame and the prompt 330 to the second recognition model 340 to determine chapter information 350 of the video content 310.

When the electronic device 110 uses the second recognition model 340 to process the image frame, the manner in which the second recognition model 340 processes each image frame in turn is different from the manner in which the second recognition model 340 processes the plurality of image frames concurrently. The above two processing manners will be described in detail below separately.

In some embodiments, for the scenario where the second recognition model 340 processes one image frame, the process in which the electronic device 110 uses the second recognition model 340 to process the image frame may be as follows: first, the image frame is divided into a set of sub-images based on size information of the image frame; then, the set of sub-images are encoded by using a visual encoder to determine a visual feature of the image frame; and finally, the visual feature and the prompt 330 are provided to the second recognition model 340 to determine the chapter information 350 of the video content 310.

In some embodiments, the electronic device 110 may divide the image frame into the set of sub-images of different sizes based on the size information of the image frame. The size information of the image frame may be, for example, the resolution and the aspect ratio of the image frame.

Specifically, when encoding the set of sub-images by using the visual encoder, the electronic device 110 may obtain a set of sub-visual features corresponding to the set of sub-images. The visual feature corresponding to the image frame may be obtained by concatenating the set of sub-visual features. The electronic device 110 uses the second recognition model 340 to process the visual features of the plurality of image frames in turn to determine the chapter information 350 of the video content 310.

In some embodiments, for the scenario where the second recognition model 340 processes the plurality of image frames concurrently, the process in which the electronic device 110 uses the second recognition model 340 to process the plurality of image frames may be as follows: first, a plurality of visual features corresponding to the plurality of image frames of the video content 310 are obtained; then, a fused visual feature is constructed by cascading the plurality of visual features; and finally, the fused visual feature and the prompt 330 are provided to the second recognition model 340 to determine the chapter information 350 of the video content 310. The visual feature corresponding to a first image frame in the plurality of image frames is a first visual feature. The plurality of visual features corresponding to the plurality of image frames include the first visual feature. The plurality of visual features are the plurality of visual features obtained by the electronic device 110 through encoding a plurality of sets of sub-images corresponding to the plurality of image frames by using the visual encoder.

In some embodiments, for example, the second recognition model 340 may be obtained based on the following training process: first, the electronic device 110 constructs a training sample set; and then, the second recognition model 340 is trained by using the training sample set. Where the training sample set includes positive samples and negative samples. The positive samples are video samples including chapter text, and the negative samples are video samples not including chapter text. As an example, the training sample set may be, for example, training data generated by further chapter recognition algorithms.

In some embodiments, during the process of training the second recognition model 340, the electronic device 110 may adopt the SFT technology. As an example, the SFT technology may specifically be Adapter, LoRA, Prefix Tuning, or Prompt Tuning.

In some embodiments, the second recognition model 340 may be, for example, a QwenVL series model, an InternVL series model, an mPLUG-Owl series model, or a MiniCPM-V series model.

Furthermore, considering that the chapter information recognized by the second recognition model 340 may be different from the real chapter information 350 in the image frame, the electronic device 110 may perform merging processing to make the determined chapter information 350 of the video content 310 more accurate.

In some embodiments, the electronic device 110 may determine the chapter information 350 of the video content 310 based on the following process: first, a plurality of image frames of the video content 310 are processed by using the second recognition model 340 to determine a plurality of sets of candidate chapter titles; and then, the chapter information 350 is determined based on the plurality of sets of candidate chapter titles.

It would be appreciated that whether the electronic device 110 uses the second recognition model 340 to process the plurality of image frames in turn or concurrently, a set of candidate chapter titles corresponding to each image frame may be finally obtained. After that, the electronic device 110 may determine the chapter information 350 based on the plurality of sets of candidate chapter titles.

In some embodiments, the electronic device 110 may determine the chapter information 350 based on the following process: first, a chapter structure is determined based on the plurality of sets of candidate chapter titles, the chapter structure indicating a plurality of chapter positions; then, for each of the plurality of chapter positions, a plurality of candidate chapter titles corresponding to each chapter position are determined based on the plurality of sets of candidate chapter titles; and finally, a chapter title corresponding to each chapter position is determined based on a frequency of each of the plurality of candidate chapter titles.

It would be appreciated that when the electronic device 110 uses the second recognition model 340 to recognize the image frame, the prompt 330 may constrain the form of the output result of the second recognition model 340, for example, the output result is separated by a predetermined character such as the symbol "|". Therefore, the text content output by the second recognition model 340 includes the predetermined character such as the symbol "|". As an example, the predetermined character may also be "..." or "/", etc.

In some embodiments, since the plurality of sets of candidate chapter titles output by the second recognition model 340 are separated by the predetermined symbol, the electronic device 110 may determine the chapter structure, that is, determine the plurality of chapter positions, based on the predetermined character in the plurality of sets of candidate chapter titles.

Since the content of the progress bar in the plurality of image frames is the same, in the case where the recognition of the second recognition model 340 is accurate, the plurality of sets of candidate chapter titles output by the second recognition model 340 should also be the same. However, the second recognition model 340 may recognize one character in the image frame as another character. Nevertheless, the second recognition model 340 may accurately recognize that the number of each set of candidate chapter titles is the same. Accordingly, the electronic device 110 may subsequently determine the plurality of chapter positions.

In some embodiments, after determining a target chapter position from the plurality of chapter positions, the electronic device 110 may determine a plurality of candidate chapter titles corresponding to the target chapter position from the plurality of sets of candidate chapter titles. Then, the electronic device 110 may determine the candidate chapter title with the highest frequency of occurrence among the plurality of candidate chapter titles as the chapter title corresponding to the target chapter position. After the electronic device 110 determines the chapter title corresponding to each chapter position in the above manner, the chapter information 350 may be obtained.

In a specific example, three sets of candidate chapter titles of the three image frames output by the second recognition model 340 may be "Title A1 | Title B1 | Title C1", "Title A2 | Title B1 | Title C2", and "Title A2 | Title B2 | Title C1". It may thus be obtained that when the target chapter position is the first chapter position, the valid characters are "Title A1", "Title A2", and "Title A2", respectively. Therefore, the chapter title of the first chapter position is "Title A2" with the highest frequency of occurrence (2 times). Similarly, it may be obtained that the chapter title of the second chapter position is "Title B1", and the chapter title of the third chapter position is "Title C1". Furthermore, it may be obtained that the chapter information 350 is "Title A2 | Title B1 | Title C1".

Through the above manner, embodiments of the present disclosure are capable of recognizing the image frame of the video content 310 by using the first recognition model 320 to determine the set of text content. Furthermore, the image frame may be recognized by using the second recognition model 340 in combination with the prompt 330 constructed based on the set of text content, to determine the chapter information 350 of the video content 310. In the above manner, embodiments of the present disclosure may improve the accuracy of recognizing the self-made chapter text in the video content.

### Example Interaction

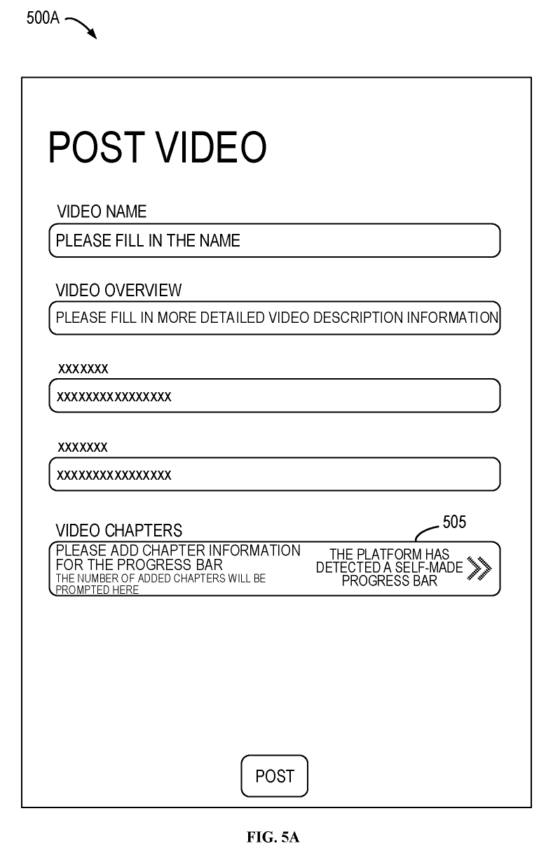

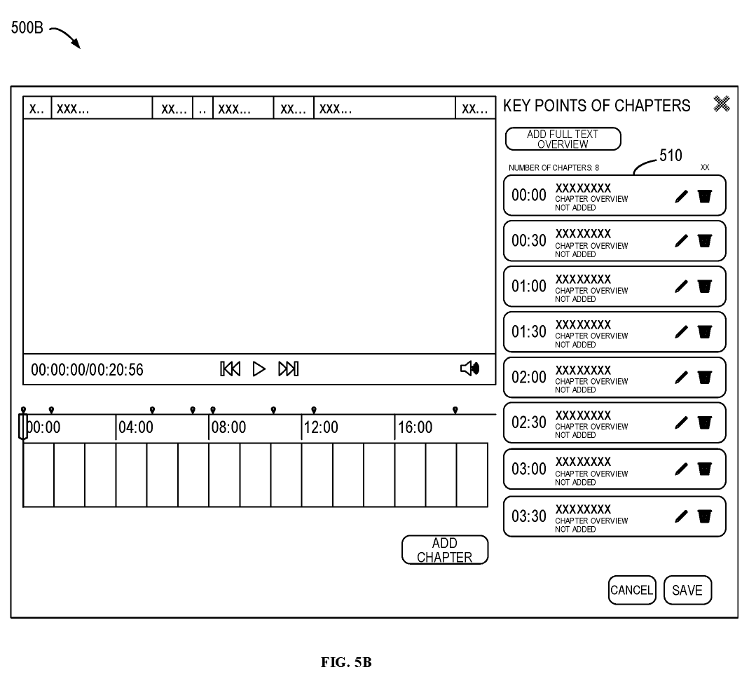

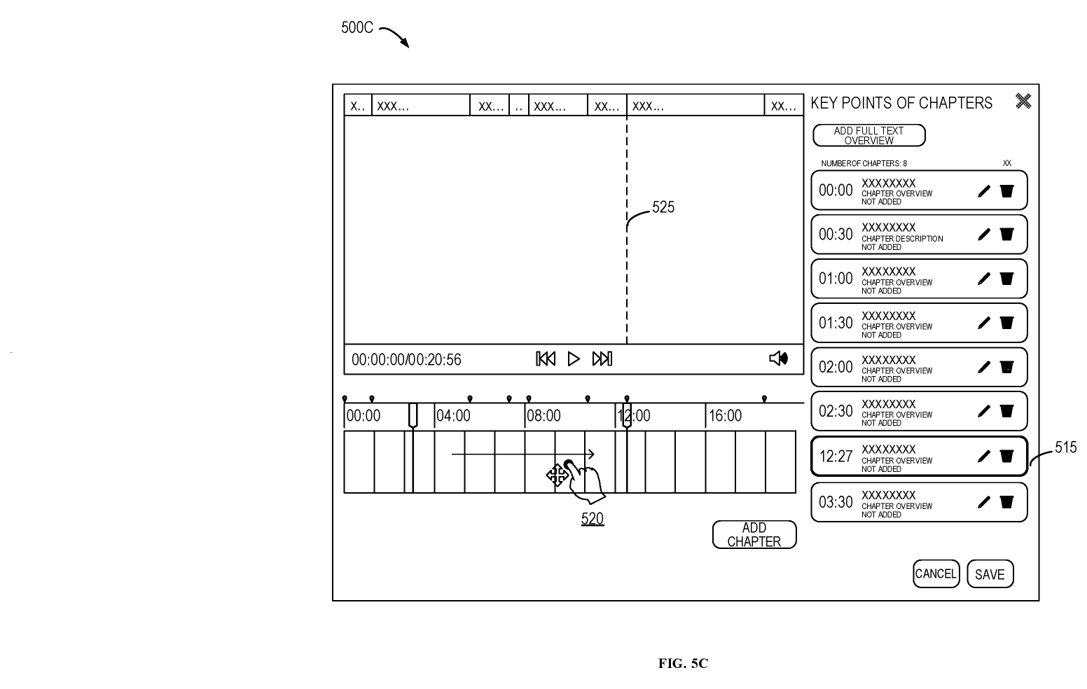

The specific interaction process of posting the video content will be described below with reference to FIGS. 5A-5C. FIGS. 5A-5C illustrate example interfaces 500A to 500C according to some embodiments of the present disclosure. The interfaces 500A to 500C may be provided, for example, by the electronic device 110 shown in FIG. 1.

As shown in FIG. 5A, in some embodiments, the electronic device 110 may present the posting interface of the video content. After receiving the video content uploaded by the user 140, the electronic device 110 may present the interface 500A as shown in FIG. 5A, so that the user 140 may edit the information related to the video content to complete the posting of the video content.

As shown in FIG. 5A, in some embodiments, the interface 500A may include a plurality of editing items and a control for posting the video content. The plurality of editing items are respectively used for editing a plurality of items of information related to the video content. The editing item may be, for example, an editing item for editing the name of the video content, an editing item for editing the overview of the video content, an editing item for editing the type to which the video content belongs, or an editing item for editing the chapter information of the video content. After the user 140 finishes editing all the editing items, when the electronic device 110 receives the click operation of the user 140 on the control, the posted video content may be presented in, for example, an interface of a social platform. Additionally, the interface 500A may further include a preview area for previewing the video content.

In some embodiments, the electronic device 110 may present guidance information 505 in the posting interface in response to obtaining first chapter information recognized based on the video content. The aforementioned editing item for editing the chapter information may be used by the user 140 to edit the chapter information of the video content. It would be appreciated that the video content uploaded by the user 140 may be video content including the chapter information produced by the user 140 or the progress bar related to the chapter information, or may be video content without the chapter information produced by the user 140 or the progress bar related to the chapter information. For the former, the electronic device 110 may recognize the chapter information in the video content. For the latter, the user 140 may add the chapter information to the video content through the editing item.

The case where the video content is the video content including the chapter information produced by the user 140 or the progress bar related to the chapter information will be further described below.

In some embodiments, the electronic device 110 may recognize the image content of the video content by calling a recognition algorithm, to obtain the recognized first chapter information. The image content may indicate, for example, a text element included in at least one image frame of the video content. It would be appreciated that the at least one image frame of the video content may present text elements such as a subtitle, a progress bar related to the chapter information, and the text content appearing in the scene corresponding to the image frame. The first chapter information may be determined therefrom by recognizing the image content including these text elements. As an example, the electronic device 110 or the server 130 may use the process 200 discussed with reference to FIG. 2 to recognize the first chapter information corresponding to the video content.

In some embodiments, when the electronic device 110 recognizes the first chapter information from the image content of the video content, the electronic device 110 may present the guidance information 505 in the publishing interface. As shown in FIG. 5A, the guidance information 505 may include that "the platform has detected a self-made progress bar".

The first chapter information may indicate a plurality of chapter titles determined based on the chapter content produced by the user 140 in the video content or the progress bar related to the chapter content. Additionally, the first chapter information may further indicate, for example, a start time point or an end time point of the plurality of chapters.

In some embodiments, the electronic device 110 may present a chapter setting interface of the video content in response to the triggering of the guidance information 505. The chapter setting interface presents a first set of chapter titles determined based on the first chapter information. As shown in FIG. 5B, in some embodiments, when the electronic device 110 receives the triggering of the guidance information 505 by the user 140, the electronic device 110 may present the chapter setting interface such as the interface 500B. The chapter setting interface may at least include an editing panel and an auxiliary panel for editing the chapter information. The user 140 may edit the chapter information by operating the editing panel and the auxiliary panel.

In some embodiments, the editing panel may include a plurality of unit panels corresponding to the first set of chapter titles. Each unit panel is used for editing the chapter information of one chapter title in the first set of chapter titles. The first set of chapter titles may be determined based on, for example, the first chapter information. For example, the interface 500B may display a plurality of chapter titles extracted from the progress bar produced by the user 140, such as a chapter title 510.

In some embodiments, the unit panel may include, for example, a first area for editing the title name of the first set of chapter titles, a second area for editing the overview of the first set of chapter titles, and a third area for editing the time point related to the first set of chapter titles. The first area may present the title name of the first set of chapter titles, for example. The second area may present the overview of the first set of chapter titles, for example. The third area may present the time point related to the first set of chapter titles, such as the start time point or the end time point of the chapter title. As an example, when the electronic device 110 receives the click operation of the user 140 on any editing area on the unit panel, the electronic device 110 may cause the corresponding editing area on the chapter setting interface to present an editing mode, so that the user 140 may edit the corresponding information. In one further example, the unit panel may further include an editing control. When the electronic device 110 receives the click operation of the user 140 on the editing control, the electronic device 110 may cause the corresponding unit panel on the chapter setting interface to present the editing mode.

In some embodiments, the electronic device 110 associates the first set of chapter titles with a first set of time points of the video content to obtain the time points presented in the third area. The first set of time points may be, for example, predetermined time points. As an example, the first set of time points may be determined based on the number of the first set of chapter titles. For example, the electronic device 110 may predetermine the first set of time points based on the ratio of the duration of the video content to the number of the first set of chapter titles. Alternatively, the electronic device 110 may predetermine the first set of time points as time points separated by a fixed duration.

In some embodiments, the auxiliary panel may at least include a video preview area and a time axis. The video preview area may be used for previewing the video content. Since the video content includes the progress bar, and the progress bar may indicate the start time point or the end time point of the plurality of chapter titles and the video playback progress, the user 140 may adjust the time point in the third area by referring to the video content in the video preview area. The time axis may be used for obtaining the time point. When the electronic device 110 receives the selection operation of the user 140 on any time point on the time axis, the electronic device 110 may obtain the specific time of the time point selected by the user 140 through the time axis. Furthermore, the electronic device 110 associates the time axis with the time point in the third area, so that the time point selected by the user 140 from the time axis may be synchronized to the third area, thereby realizing the adjustment of the time point in the third area.

Additionally, the chapter setting interface may further include a control for adding and deleting chapters.

It would be appreciated that the scenario of presenting the chapter setting interface through the triggering of the guidance information 505 may be, for example, that the user 140 uploads the video content including the first chapter information for the first time. The user 140 may operate the guidance information 505 to cause the electronic device 110 to present the setting interface to edit the chapter information of the video content. For one further scenario, that is, the scenario where the user 140 edits the chapter information of the video content not for the first time, the user 140 may click the editing item for editing the chapter information or the control corresponding thereto, to cause the electronic device 110 to present the chapter setting interface. Specifically, when the electronic device 110 receives the click operation of the user 140 on the editing item or the corresponding control, the electronic device 110 may present the chapter setting interface.

In some embodiments, the electronic device 110 may determine second chapter information of the video content via the chapter setting interface, to post the video content. The second chapter information at least indicates a second set of chapter titles of the video content. As an example, the user 140 may confirm the plurality of chapter titles indicated by the first chapter information, and may post the video to associate the video with the plurality of automatically recognized chapter titles.

In some further embodiments, the electronic device 110 may further receive an editing operation on the first set of chapter titles to add a new chapter title, modify an existing chapter title, or modify an existing chapter title. Accordingly, the electronic device 110 may determine the second set of chapter titles.

Additionally, the second chapter information may indicate, for example, the chapter overview corresponding to the second set of chapter titles and the start time point or the end time point of the second set of chapter titles in the video content.

It would be appreciated that since the second chapter information may be at least divided into three parts, namely, the second set of chapter titles, the chapter overview, and the corresponding start time point or end time point, the implementation of the aforementioned step of "determining the second chapter information of the video content" may also be divided into the implementation of the three parts.

For determining the second set of chapter titles, in some embodiments, the second set of chapter titles may be determined based on the first set of chapter titles. As an example, when receiving an operation of adding, deleting, or modifying the first set of chapter titles from the user 140, the electronic device 110 may adjust the first set of chapter titles to the second set of chapter titles and present them in the editing panel.

In a specific example, when the electronic device 110 receives the click operation of the user 140 on the first area or the editing control of a unit panel, the electronic device 110 causes the first area to enter the editing mode. Then, when the electronic device 110 receives the input operation of the user 140 in the first area, the electronic device 110 causes the first area to present the chapter title input by the user 140. Through the above process, the electronic device 110 may adjust the first set of chapter titles to the second set of chapter titles via the chapter setting interface. The process of adjusting the first set of chapter titles to the second set of chapter titles based on the operation of adding a chapter or the operation of deleting a chapter is similar to the above process, which will not be repeated here.

For determining the chapter overview corresponding to the second set of chapter titles, reference may be made to the implementation process of determining the second set of chapter titles for its implementation process, which will not be repeated here.

For determining the start time point or the end time point corresponding to the second set of chapter titles, in some embodiments, the electronic device 110 may implement it based on the following process: associating the second set of chapter titles with a second set of time points of the video content via the chapter setting interface. Specifically, the second set of time points may be determined based on the editing operation of the user 140.

As shown in FIG. 5C, the electronic device 110 presents an indication element 525 in the video area of the chapter setting interface in response to the selection of a chapter title 515 in the second set of chapter titles. In some embodiments, after receiving the selection operation of the user on the chapter title 515 in the second set of chapter titles, the electronic device 110 may cause the unit panel corresponding to the chapter title 515 in the chapter setting interface to present the selected state. As an example, the selected state may be represented by marking the unit panel with color or bolding the outline of the unit panel.

In some embodiments, the indication element may represent the start time point or the end time point corresponding to the chapter title. When the time point in the third area is represented as the start time point of the chapter title, the indication element may represent the start time point corresponding to the chapter title. On the contrary, when the time point in the third area is represented as the end time point of the chapter title, the indication element may represent the end time point corresponding to the chapter title. As an example, the indication element 525 may be an auxiliary line.

Then, the electronic device 110 updates the position of the indication element 525 in the video preview area in response to receiving an adjustment operation 520 on the start time point or the end time point. When receiving the drag-and-drop operation 520 of the user 140, the indication element 525 may move accordingly to indicate the adjusted start time point or end time point.

In this manner, the embodiment of the present disclosure may help the user to more accurately locate the boundary positions between different chapters by displaying the indication element, thereby improving the efficiency of setting the chapter information.

### Example Apparatus Device

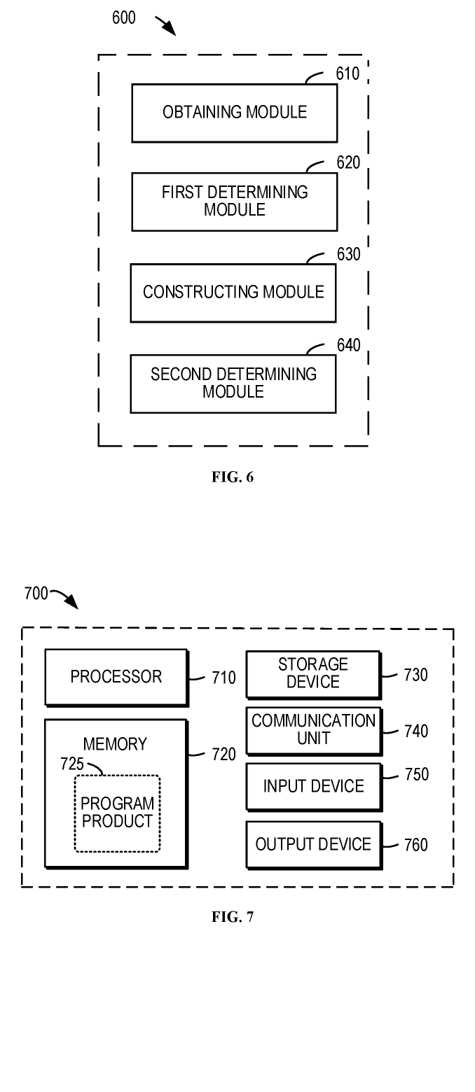

The embodiment of the present disclosure further provides a corresponding apparatus for implementing the above method or process. FIG. 6 illustrates a schematic structural block diagram of an example apparatus 600 for chapter recognition according to some embodiments of the present disclosure. The apparatus 600 may be implemented as or included in the electronic device 110. Each module/component in the apparatus 600 may be implemented by hardware, software, firmware, or any combination thereof.

As shown in FIG. 6, the apparatus 600 includes: an obtaining module 610 configured to obtain an image frame of video content; a first determining module 620 configured to determine, a set of text content in the image frame by using a first recognition model; a constructing module 630 configured to construct a prompt based on the set of text content; and a second determining module 640 configured to provide the image frame and the prompt to a second recognition model to determine chapter information of the video content, the chapter information indicating a plurality of chapter titles of the video content.

In some embodiments, the prompt includes a feature description associated with chapter text to be recognized.

In some embodiments, the feature description indicates at least one of: a position feature of the chapter text, a dynamic change feature of the chapter text, and a static visual feature of the chapter text.

In some embodiments, the image frame is a first image frame, and providing the image frame and the prompt to the second recognition model to determine the chapter information of the video content includes: using the second recognition model to process a plurality of image frames of the video content to determine a plurality of sets of candidate chapter titles, the plurality of image frames including the first image frame and at least one second image frame; and determining the chapter information based on the plurality of sets of candidate chapter titles.

In some embodiments, determining the chapter information based on the plurality of sets of candidate chapter titles includes: determining a chapter structure based on the plurality of sets of candidate chapter titles, the chapter structure indicating a plurality of chapter positions; determining, for each chapter position of the plurality of chapter positions, a plurality of candidate chapter titles corresponding to each chapter position based on the plurality of sets of candidate chapter titles; and determining a chapter title corresponding to each chapter position based on a frequency of each of the plurality of candidate chapter titles.

In some embodiments, providing the image frame and the prompt to the second recognition model to determine the chapter information of the video content includes: dividing the image frame into a set of sub-images based on size information of the image frame; encoding the set of sub-images by using a visual encoder to determine a visual feature of the image frame; and providing the visual feature and the prompt to the second recognition model to determine the chapter information of the video content.

In some embodiments, the image frame is a first image frame, the visual feature is a first visual feature, and providing the visual feature and the prompt to the second recognition model to determine the chapter information of the video content includes: obtaining a plurality of visual features corresponding to a plurality of image frames of the video content, the plurality of visual features including the first visual feature; constructing a fused visual feature by cascading the plurality of visual features; and providing the fused visual feature and the prompt to the second recognition model to determine the chapter information of the video content.

In some embodiments, constructing the prompt based on the set of text content includes: determining position information of the set of text content in the video content; and constructing the prompt based on the set of text content and the position information.

In some embodiments, the prompt further indicates layout information of the set of text content in the video content.

In some embodiments, the second recognition model is trained based on the following process. a training sample set is constructed, the training sample set including positive samples and negative samples, the positive samples being video samples including chapter text, and the negative sample being video samples not including chapter text; and the second recognition model is trained by using the training sample set.

In some embodiments, the first recognition model includes an optical character recognition (OCR) model.

As shown in FIG. 7, a computing device 700 is in the form of a general electronic device. The components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and may perform various processes based on the programs stored in the memory 720. In a multi-processor system, a plurality of processing units execute computer executable instructions in parallel to improve the parallel processing capability of the computing device 700.

The computing device 700 typically includes a plurality of computer storage medium. Such medium may be any available medium that is accessible to the computing device 700, including, but not limited to, volatile and non-volatile medium, and removable and non-removable medium. The memory 720 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine-readable medium such as a flash drive, a disk, or any other medium, which may be used to store information and/or data and may be accessed within the computing device 700.

The computing device 700 may further include additional removable/non-removable, volatile/non-volatile storage medium. Although not shown in FIG. 7, a disk driver for reading from or writing into removable and non-volatile disks (such as a "floppy disk"), and an optical disk driver for reading from or writing into removable and non-volatile optical disks may be provided. In these cases, each driver may be connected to the bus (not shown) by one or more data medium interfaces. The memory 720 may include a computer program product 725 having one or more program modules configured to perform various methods or acts of the various embodiments of the present disclosure.

The communication unit 740 implements communication with other electronic devices through the communication medium. Additionally, the functions of the components of the computing device 700 may be implemented by a single computing cluster or a plurality of computing machines, which may communicate through communication connections. Therefore, the computing device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The computing device 700 may further communicate with one or more external devices (not shown) through the communication unit 740 as needed, the external devices such as a storage device, a display device, etc., communicate with one or more devices that enable the user to interact with the computing device 700, or communicate with any devices (such as a network card, a modem, etc.) that enable the computing device 700 to communicate with one or more other electronic devices. Such communication may be performed via input/output (I/O) interfaces (not shown).

According to an example implementation of the present disclosure, a computer-readable storage medium is provided, having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, and the computer executable instructions are executed by a processor to implement the method described above.

Various aspects of the present disclosure are described herein with reference to the flowcharts and/or block diagrams of the method, apparatus, device, and computer program product implemented according to the present disclosure. It would be appreciated that each block of the flowchart and/or block diagram, and the combination of each block in the flowchart and/or block diagram may be implemented by computer-readable program instructions.

These computer-readable program instructions may be provided to the processing unit of a general computer, a dedicated computer, or other programmable data processing apparatus to produce a machine, so that when these instructions are executed by the processing unit of the computer or other programmable data processing apparatus, an apparatus for implementing the functions/actions specified in one or more blocks in the flowchart and/or block diagram is produced. These computer-readable program instructions may also be stored in a computer-readable storage medium, which instructions cause the computer, the programmable data processing apparatus, and/or other devices to work in a specific manner, so that the computer-readable medium having the instructions stored thereon includes a manufactured product, which includes instructions for implementing various aspects of the functions/actions specified in one or more blocks in the flowchart and/or block diagram.

The computer-readable program instructions may be loaded onto a computer, another programmable data processing apparatus, or other devices, causing a series of operation steps to be performed on the computer, another programmable data processing apparatus, or other devices to produce a computer-implemented process, so that the instructions executed on the computer, other programmable data processing apparatus, or other devices implement the functions/actions specified in one or more blocks in the flowchart and/or block diagram.

The flowchart and block diagram in the drawings show the possibly implemented architectures, functions, and operations of the system, the method, and the computer program product according to multiple implementations of the present disclosure. In this regard, each block in the flowchart or block diagram may represent a module, a program segment, or a part of instructions, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block in the block diagram and/or the flowchart, and the combination of the blocks in the block diagram and/or the flowchart may be implemented by a dedicated hardware-based system that executes specified functions or actions, or may be implemented by a combination of dedicated hardware and computer instructions.

The implementations of the present disclosure have been described above, and the above description is example, non-exhaustive, and not limited to the disclosed implementations. Without departing from the scope and spirit of the described implementations, many modifications and changes would be apparent to those of ordinary skill in the art. The terms used herein are chosen to best explain the principles, practical applications, or improvements to the technology in the market of the implementations, or to enable other ordinary skilled persons in the art to understand the implementations disclosed herein.

1. A method for chapter recognition, comprising:
obtaining an image frame of video content;
determining a set of text content in the image frame;
constructing a prompt based on the set of text content; and
providing the image frame and the prompt to a second recognition model to determine chapter information of the video content, the chapter information indicating a plurality of chapter titles of the video content.

2. The method of claim 1, wherein the prompt comprises a feature description associated with chapter text to be recognized.

3. The method of claim 2, wherein the feature description indicates at least one of:
a position feature of the chapter text;
a dynamic change feature of the chapter text; or
a static visual feature of the chapter text.

4. The method of claim 1, wherein the image frame is a first image frame, and providing the image frame and the prompt to the second recognition model to determine the chapter information of the video content comprises:
using the second recognition model to process a plurality of image frames of the video content to determine a plurality of sets of candidate chapter titles, the plurality of image frames comprising the first image frame and at least one second image frame; and
determining the chapter information based on the plurality of sets of candidate chapter titles.

5. The method of claim 4, wherein determining the chapter information based on the plurality of sets of candidate chapter titles comprises:
determining a chapter structure based on the plurality of sets of candidate chapter titles, the chapter structure indicating a plurality of chapter positions;
determining, for each chapter position of the plurality of chapter positions, a plurality of candidate chapter titles corresponding to each chapter position based on the plurality of sets of candidate chapter titles; and
determining a chapter title corresponding to each chapter position based on a frequency of each of the plurality of candidate chapter titles.

6. The method of claim 1, wherein providing the image frame and the prompt to the second recognition model to determine the chapter information of the video content comprises:
dividing the image frame into a set of sub-images based on size information of the image frame;
encoding the set of sub-images by using a visual encoder to determine a visual feature of the image frame; and
providing the visual feature and the prompt to the second recognition model to determine the chapter information of the video content.

7. The method of claim 6, wherein the image frame is a first image frame, the visual feature is a first visual feature, and providing the visual feature and the prompt to the second recognition model to determine the chapter information of the video content comprises:
obtaining a plurality of visual features corresponding to a plurality of image frames of the video content, the plurality of visual features comprising the first visual feature;
constructing a fused visual feature by cascading the plurality of visual features; and
providing the fused visual feature and the prompt to the second recognition model to determine the chapter information of the video content.

8. The method of claim 1, wherein constructing the prompt based on the set of text content comprises:
determining position information of the set of text content in the video content; and
constructing the prompt based on the set of text content and the position information.

9. The method of claim 1, wherein the prompt further indicates layout information of the set of text content in the video content.

10. The method of claim 1, wherein the second recognition model is trained based on the following process:
constructing a training sample set, the training sample set comprising positive samples and negative samples, the positive samples being video samples comprising chapter text, and the negative sample being video samples not comprising chapter text; and
training the second recognition model by using the training sample set.

11. The method of claim 1, wherein the first recognition model comprises an optical character recognition (OCR) model.

12. A computing device, comprising:
at least one processor; and
at least one memory coupled to the at least one processor and storing instructions executable by the at least one processor, the instructions, when executed by the at least one processor, causing the computing device to perform acts comprising:
obtaining an image frame of video content;
determining a set of text content in the image frame;
constructing a prompt based on the set of text content; and
providing the image frame and the prompt to a second recognition model to determine chapter information of the video content, the chapter information indicating a plurality of chapter titles of the video content.

13. The computing device d of claim 12, wherein the prompt comprises a feature description associated with chapter text to be recognized.

14. The computing device of claim 13, wherein the feature description indicates at least one of:
a position feature of the chapter text;
a dynamic change feature of the chapter text; or
a static visual feature of the chapter text.

15. The computing device of claim 12, wherein the image frame is a first image frame, and providing the image frame and the prompt to the second recognition model to determine the chapter information of the video content comprises:
using the second recognition model to process a plurality of image frames of the video content to determine a plurality of sets of candidate chapter titles, the plurality of image frames comprising the first image frame and at least one second image frame; and
determining the chapter information based on the plurality of sets of candidate chapter titles.

16. The computing device of claim 15, wherein determining the chapter information based on the plurality of sets of candidate chapter titles comprises:
determining a chapter structure based on the plurality of sets of candidate chapter titles, the chapter structure indicating a plurality of chapter positions;
determining, for each chapter position of the plurality of chapter positions, a plurality of candidate chapter titles corresponding to each chapter position based on the plurality of sets of candidate chapter titles; and
determining a chapter title corresponding to each chapter position based on a frequency of each of the plurality of candidate chapter titles.

17. The computing device of claim 12, wherein providing the image frame and the prompt to the second recognition model to determine the chapter information of the video content comprises:
dividing the image frame into a set of sub-images based on size information of the image frame;
encoding the set of sub-images by using a visual encoder to determine a visual feature of the image frame; and
providing the visual feature and the prompt to the second recognition model to determine the chapter information of the video content.

18. The computing device of claim 17, wherein the image frame is a first image frame, the visual feature is a first visual feature, and providing the visual feature and the prompt to the second recognition model to determine the chapter information of the video content comprises:
obtaining a plurality of visual features corresponding to a plurality of image frames of the video content, the plurality of visual features comprising the first visual feature;
constructing a fused visual feature by cascading the plurality of visual features; and
providing the fused visual feature and the prompt to the second recognition model to determine the chapter information of the video content.

19. The computing device of claim 12, wherein constructing the prompt based on the set of text content comprises:
determining position information of the set of text content in the video content; and
constructing the prompt based on the set of text content and the position information.

20. A non-transitory computer-readable storage medium having a computer program stored thereon, the computer program being executable by a processor to implement acts comprising:
obtaining an image frame of video content;
determining a set of text content in the image frame;
constructing a prompt based on the set of text content; and
providing the image frame and the prompt to a second recognition model to determine chapter information of the video content, the chapter information indicating a plurality of chapter titles of the video content.
